(19) United States
(12) Patent Application Publication
(10) Pub. No.: US 2026/0106186 A1
(43) Pub. Date: Apr. 16, 2026

(54) AIRCRAFT FUEL CELL PROPULSION UNIT

(71) Applicant: MTU Aero Engines AG, München (DE)

(72) Inventors: Stephan Lellek, Garching (DE); Barnaby Law, Starnberg (DE)

(73) Assignee: MTU Aero Engines AG, München (DE)

(21) Appl. No.: 19/104,996

(22) PCT Filed: Aug. 21, 2023
(86) PCT No.: PCT/DE2023/100613

§ 371 Date: Feb. 19, 2025

(30) Foreign Application Priority Data
Aug. 23, 2022 (DE) 10 2022 121 215.7

(51) Int. Cl. H01M 8/04029; B60L 50/70; B64D 27/355; B64D 33/10; H01M 8/04119; H01M 8/04746

(52) U.S. Cl. CPC H01M 8/04029; B60L 50/70; B64D 27/355; B64D 33/10; H01M 8/04156; H01M 8/04768; B60L 2200/10

(57) ABSTRACT

The invention relates to an aircraft fuel cell propulsion unit comprising a fuel cell system that includes at least one anode and at least one cathode as well as a process gas device for supplying the anode and the cathode with fuel and ambient air and for discharging used process gases, a ram air duct through which ram air flows and a heat exchanger arranged in the ram air duct which is designed to dissipate heat generated by the fuel cell system to the environment.

### BACKGROUND OF THE INVENTION

The invention relates to an aircraft fuel cell propulsion unit with a fuel cell system which has at least one anode and at least one cathode as well as a process gas device for supplying the anode and the cathode with fuel and ambient air and for discharging used process gases. The invention also relates to a method for operating such an aircraft fuel cell propulsion unit.

In order to make aircraft more environmentally friendly, efforts are being made to use fuel cells as energy converters for aircraft propulsion. In propulsion systems with fuel cells, large amounts of waste heat are typically generated at a low temperature level during operation, which is why a liquid cooling system for the fuel cells is required that can dissipate the waste heat to the environment in order to enable safe, stable operation of the fuel cells. A central component for dissipating heat from this liquid cooling system to the environment is a large (main) heat exchanger. This is typically arranged in or on a ram air duct of an engine in the free air flow or behind a propeller. In order to achieve a sufficient cooling effect, such a main heat exchanger must have large dimensions, can therefore only be integrated into the aircraft in an unsatisfactory manner and can create large additional aerodynamic drag on the aircraft.

### SUMMARY OF THE INVENTION

Based on this, it is a task of the present invention to propose an improved aircraft fuel cell propulsion unit with which, in particular, aerodynamic properties of the propulsion unit can be improved and/or maintenance effort can be reduced. Furthermore, a method for operating such an aircraft fuel cell propulsion unit is to be provided. According to the invention, this is achieved by the teachings of the independent claims. Advantageous embodiments of the invention are the subject of the subclaims.

To solve the problem, an aircraft fuel cell propulsion unit with a fuel cell system is proposed, wherein the fuel cell system has at least one anode and at least one cathode as well as a process gas device for supplying the anode and the cathode with fuel and ambient air as well as for the removal of used process gases. In addition, the aircraft fuel cell propulsion unit has a ram air duct through which ram air flows and a heat exchanger arranged in the ram air duct, which is set up to dissipate heat generated by the at least one fuel cell to the environment, wherein a supply device being arranged upstream of the heat exchanger, which is set up to introduce water into the ram air flow. The water is at least partially provided from the process gas of the fuel cell system by a recovery device.

The chemical reaction of hydrogen and oxygen in the fuel cell system during operation produces highly pure, deionized water. By the recovery device, a particularly liquid water component can be separated from the process gas and fed into a water reservoir of the recovery device and/or fed to the ram air flow. Thus, the operation of the fuel cell system can be used to provide highly pure water, which in particular fulfills specific operating requirements. By using the deionized water produced or recovered in this way, contamination and/or the formation of deposits on or in the heat exchanger can be reduced or even avoided. This can reduce the risk of damage and/or maintenance effort for the heat exchanger. The integration of a water supply for improved heat transfer in or at the heat exchanger, which is made possible by the proposed aircraft fuel cell propulsion unit, means that there is no need for an external supply of water, which can result in cost savings.

By supplying or injecting liquid, deionized water into the ram air duct at the inlet of the heat exchanger, heat transfer at or in the main heat exchanger can be increased. Experimental studies show a potential increase in performance of up to 50% in relation to the amount of waste heat transferred per surface area. Since the total amount of heat to be dissipated on the aircraft or aircraft fuel cell propulsion unit remains unchanged, this results in a potential for reducing the size of the main heat exchanger, which can, for example, result in a reduction in the inflow area, volume and weight of the (main) heat exchanger. As a result, it can be better integrated into the aircraft fuel cell propulsion unit, which can reduce drag or flow losses on the aircraft. Overall, this can result in an improvement in the overall efficiency of the aircraft fuel cell drive or the aircraft.

A fuel cell system has at least one fuel cell, in particular a plurality of fuel cells, which are arranged, for example, in the form of fuel cell stacks. Such a fuel cell arrangement, which accordingly has at least one fuel cell, is also referred to in simplified terms as “a fuel cell” in the context of the description of the invention. Accordingly, the plurality of fuel cells usually also has a plurality of anodes, which are supplied with a fuel, such as in particular hydrogen, to generate electrical energy, and a plurality of cathodes, which are supplied with ambient air in cooperation with the anodes to generate electrical energy, in order to supply the atmospheric oxygen contained therein to the fuel cell as an oxidizing agent.

A process gas device is set up to carry process gas and supplies the fuel cell or the fuel cell system with reactants required for the generation of electrical energy via the process gas and removes used process gas or reaction gas from the fuel cell. For this purpose, the process gas device is set up to supply the anode with fuel and to supply the cathode with oxidizing agent as well as to remove or circulate at least partially used process gases in particular. The process gas device can thus form an open gas circuit.

When operating a fuel cell, a reducing agent such as hydrogen is supplied to the anode and an oxidizing agent such as ambient air is supplied to the cathode. At the anode, the hydrogen is catalytically oxidized to hydrogen ions by releasing electrons. These pass through the electrolyte, which is usually in the form of a membrane, into the cathode area, where they react with the oxygen supplied to the cathode and the electrons conducted to the cathode via an external circuit to form water.

In order to enable stable operation of the fuel cell system, it can be cooled by a cooling system or a coolant circuit. This coolant circuit can be connected to the (main) heat exchanger, wherein the heat exchanger is set up to absorb heat generated by the at least one fuel cell, and in particular heat transported to the heat exchanger by the coolant circuit, and/or to release it to the environment. For this purpose, the heat exchanger can have at least one cooling surface connected to the coolant circuit, over which a fan and/or ram air flow flows during operation. The cooling surface of the heat exchanger absorbs heat from the coolant circuit and dissipates it from the heat exchanger, in particular by convection. Within the scope of the invention, the heat exchanger can also have a plurality of heat exchanger devices arranged spatially next to one another and/or distributed, which can in particular (each) have a plurality of cooling surfaces. In this context, a cooling surface is any surface arranged on the heat exchanger which is heated by the thermal energy to be dissipated and from which heat can be dissipated by a ram air flow passing over it.

In order to improve the heat transfer in the heat exchanger or on the cooling surfaces, liquid water or water in a liquid aggregate state is introduced into the ram air flow by the supply device. In particular, the supply device is designed to discharge the water into the ram air flow or the ram air duct, in particular to inject, spray and/or atomize it, whereby the water can be introduced into the flow with an increased volume-to-surface ratio and/or with a uniform distribution over the cross-section of the ram air flow. By supplying water, cooling of the ram air flow can be achieved and/or heat transfer between the ram air flow and the cooling surfaces of the heat exchanger can be improved, in particular by a water-based change in the thermal conductivity of the ram air flow. This can increase the thermal efficiency or power density of the (main) heat exchanger and thus, in particular, reduce the size of the heat exchanger.

In one embodiment, the recovery device comprises at least one water separator. In particular, the recovery device is connected to the process gas device on an output side of the fuel cell system, in particular in a fluid-carrying manner, in order to be able to separate water present in the reaction gas. By the water separator, a particularly liquid water component can be separated from the process gas or reaction gas of the fuel cell system and can, for example, be fed into a water reservoir of the recovery device, collected there and/or fed to the ram air flow or the heat exchanger. The water recovered by the water separator can be made available to the supply device so that it can be introduced into the ram air flow in order to increase a potential heat transfer between the ram air flow and the heat exchanger. Because the water recovered in this way is deionized, impurities and the associated susceptibility to defects in the heat exchanger can be reduced.

In one embodiment, the process gas is a reaction gas on the anode side and/or a reaction gas on the cathode side. For example, the water separator can be in fluid connection with an exhaust gas line and/or a gas recirculation of the process gas device or a gas connection of the water separator can be fluidly connected to a cathode outlet or an anode outlet of the fuel cell system in order to be able to separate liquid water from the respective reaction gas.

Since water can be present in both the anode-side reaction gas and the cathode-side reaction gas, particularly in the gaseous state, in some embodiments a condenser is provided upstream or downstream of a respective water separator in order to improve the separation of water from the reaction gas. This allows a water reservoir for the recovered water to be smaller than in a system without a condenser, which reduces the system weight in the aircraft.

In some embodiments, the recovery device may only be provided on the anode side, in further embodiments, the recovery device may only be provided on the cathode side and in yet further embodiments, the recovery device may be provided on both the anode side and the cathode side in order to enable water recovery. The recovery of water made possible in this way enables continuous operation of the water supply to the ram air flow, whereby the performance increase of the heat exchanger is also possible during cruise flight.

In one embodiment, the supply device is set up to introduce the water into the ram air flow in atomized form. In this case, the supply device can be set up to inject, spray and/or atomize the water into the exhaust gas flow and, in particular, have an injection, nozzle and/or atomization device arranged at a supply point of the water into the ram air flow for this purpose. A degree of atomization or a droplet size of the water to be supplied can be adjusted by the supply device. A high degree of atomization of the water or a small droplet size of the water can promote heat transfer between the ram air flow and the heat exchanger, as the number of water droplets and thus their surface area available for heat exchange can be increased. Furthermore, the atomized water can be distributed evenly in the ram air flow to enable an improvement in efficiency over the entire cross-section of the ram air flow.

In one embodiment, the supply device comprises a pulse valve. The pulse valve can be arranged between a pump of the supply device and a supply point of the water in the ram air flow. In particular, the supply device is connected to the water reservoir of the recovery device in a fluid-carrying manner and is set up to transport water to an injection, nozzle and/or atomization device at the supply point.

The pulse valve can be used to control a water flow rate at an injection, nozzle and/or atomization device arranged at the supply point or the water can be introduced into the ram air flow by the pulse valve. For this purpose, the pulse valve is designed, for example, as a pilot-controlled 2/2-way valve and/or is configured to enable water transport at predetermined time intervals and/or quantities, thereby enabling improved atomization of the water over a wide operating range.

The pulse valve can be configured to pulse the water or to generate a pulsating water flow and/or to adjust an amplitude and/or a frequency of the pulsating water flow. This allows the water to be supplied to the ram air flow, for example in batches and/or at a predetermined pressure, in order to influence the distribution of the water in the ram air flow. In addition, the pulse valve can be set up to adjust or vary a pulse duration, a temperature (heating and/or cooling) of the water and/or a predetermined operating pressure for the water, for example in order to be able to adapt the properties of the water to be supplied to the operating parameters of the ram air flow or the aircraft fuel cell propulsion unit.

According to a further aspect, a method for operating an aircraft fuel cell propulsion unit with at least one fuel cell system is proposed. The aircraft fuel cell propulsion unit is designed in particular as described above. In the proposed method, the ram air duct is flowed through with ram air, the fuel cell system is operated and water is supplied to the ram air flow by the supply device, in particular before or when it enters the heat exchanger.

In this case, the aircraft fuel cell propulsion unit can have a control device that is set up to control the supply device, the recovery device, the pulse valve and/or the heat exchanger. In particular, a degree of heat dissipation or a heat transfer at or by the (main) heat exchanger(s) can be adjusted by regulating a coolant flow rate of the heat exchanger and/or a water supply to the ram air flow Thus, a heat exchange performance of the heat exchanger can be changed by the control device. The control device can specify a respective operating state or a heat exchange performance for the heat exchanger, for example depending on an ambient temperature, a ram air humidity, a ram air flow velocity and/or taking into account other operating parameters, such as the fuel cell system.

In one embodiment, the water is at least partially obtained from a process gas of the fuel cell system. The process gas is an anode-side reaction gas and/or a cathode-side reaction gas. Since the reaction of hydrogen and oxygen in the fuel cell system produces reaction gases containing highly-pure, deionized water, which are discharged from the fuel cell and/or at least partially recirculated to the anode and/or cathode, this water can be separated from the anode-side and/or cathode-side reaction gas, in particular by the recovery device, and fed to the ram air flow. The purity of the water obtained in this way can reduce or even prevent contamination and/or the formation of deposits on or in the heat exchanger in order to reduce the likelihood of damage and/or a reduction in efficiency.

In one embodiment, a volumetric flow rate of the water to be supplied can be preset depending on the parameters of the aircraft fuel cell propulsion unit, in particular by controlling the pulse valve. In this case, an injection, nozzle and/or atomization device arranged at a point where the water is supplied into the ram air flow can be set up to adjust the volume flow. Parameters of the aircraft fuel cell propulsion unit may include, for example, a current temperature, a speed, a pressure, a composition and/or a specific weight of the ram air flow. In addition, operating parameters of the aircraft engine or an environment can also be taken into account when determining the volume flow to be supplied. This allows the heat transfer performance of the heat exchanger and, in particular, water recovery from the process gas of the fuel cell system to be operated efficiently under varying conditions.

In one embodiment, the degree of atomization of the water to be introduced can be varied, in particular by controlling the pulse valve, depending on the parameters of the aircraft fuel cell propulsion unit and in particular on the operating parameters of the aircraft engine and/or an environment. When supplying water with a high degree of atomization, the smallest possible water droplets are supplied to the ram air flow, whereby the evaporation in the heat exchanger can be influenced by the number of water droplets with the same supply quantity. This can, for example, increase the heat transfer performance of the heat exchanger or keep it constant if required.

Further features, advantages and possible applications of the invention are apparent from the following description in connection with the figures. In general, features of the various exemplary aspects and/or embodiments described herein may be combined with each other, unless clearly excluded in the context of the disclosure.

### BRIEF DESCRIPTION OF THE DRAWING FIGURES

In the following part of the description, reference is made to the figures shown to illustrate specific aspects and embodiments of the present invention. It is understood that other aspects may be utilized and structural or logical changes to the illustrated embodiments are possible without departing from the scope of the present invention. The following description of the figures is therefore not intended to be limiting.

FIG. 1 shows a schematic representation of an exemplary aircraft fuel cell propulsion unit according to the invention with a fuel cell system;

FIG. 2 shows a schematic representation of a flow chart of a method according to the invention for operating an aircraft fuel cell propulsion unit with a fuel cell system.

### DESCRIPTION OF THE INVENTION

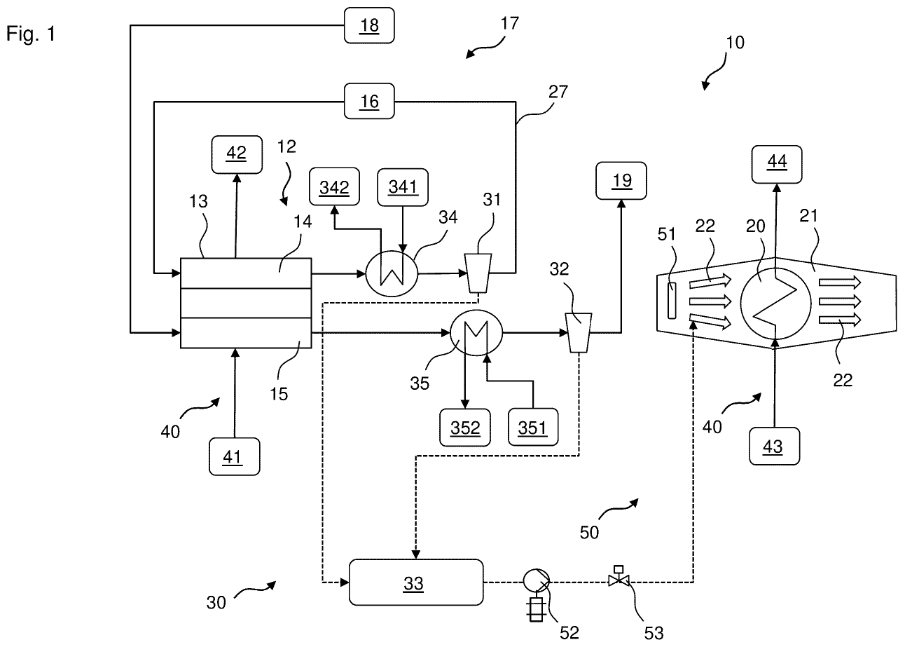

FIG. 1 shows a schematic representation of an exemplary aircraft fuel cell propulsion unit 10 according to the invention, comprising a fuel cell system 12 and a heat exchanger 20. In order to be able to operate the fuel cell system 12 reliably, it is necessary to cool it. For this purpose, a fluid cooling device 40 is provided, which can transport heat generated by the fuel cell system 12 to the heat exchanger 20 by a cooling fluid, where the heat is released to the environment by the heat exchanger 20. For this purpose, the cooling fluid can be fed to the fuel cell system 12 via a cooling fluid supply 41, absorb heat there and be discharged from there via a cooling fluid discharge 42. In order to cool the cooling fluid, it is fed to a cooling fluid supply 43 of the heat exchanger 20 by the fluid cooling device 40, where heat is extracted from it. The cooling fluid can then be discharged from there via a cooling fluid outlet 44. The cooling fluid supply lines 41, 43 or cooling fluid discharge lines 42, 44 can form a coolant circuit (not shown).

The fuel cell system 12 has a fuel cell 13 with an anode 14 and a cathode 15. The anode 14 is supplied with fuel, in the exemplary embodiment hydrogen, from a fuel storage tank 16 via a process gas device 17 and the fuel is largely consumed in the fuel cell 13. The consumed process gas or the anode-side reaction gas is discharged from the fuel cell 13. Fuel that is not completely consumed, or excess hydrogen, can be fed back to the anode 14 of the fuel cell 13 via the process gas by gas recirculation 27 or, in particular, released into the environment. The cathode 15 is supplied with ambient air taken from the environment 18 via the process gas device 17 and reacts as process gas in the fuel cell 13. The used ambient air or the reaction gas on the cathode side can be discharged from the fuel cell 13 by the process gas device 17 and, in particular, released into the environment 19.

The heat exchanger 20 is arranged in or on a ram air duct 21 through which ram air 22 flows and is designed to dissipate heat generated by the fuel cell system 12 to the environment 23. A supply device 50 is arranged upstream of the heat exchanger 20 and is designed to introduce water into the ram air flow 22. For this purpose, the supply device 50 has a nozzle device 51 arranged at or before the entry of the ram air flow 22 into the heat exchanger 20, which is designed to introduce the water into the ram air flow 22 in atomized form. The supplied water can be used to increase a cooling effect of the heat exchanger 20 or a heat transfer at and/or in the heat exchanger 20.

The water is at least partially provided by a recovery device 30 from the process gas of the fuel cell system 12.

The recovery device 30 has a first water separator 31 which is fluidly connected to an anode-side section of the process gas device 17 downstream of the fuel cell system 12 and is configured to separate water from an anode-side reaction gas. To additionally in order to obtain water from the anode-side reaction gas, a first condenser 34 can be provided upstream of the first water separator 31, which can have a cooling circuit with a coolant supply 341 and a coolant discharge 342.

In the illustrated embodiment, the recovery device 30 has a second water separator 32 which is fluidly connected to a cathode-side section of the process gas device 17 downstream of the fuel cell system 13 and is configured to separate water from a cathode-side reaction gas.

In order to additionally extract water from the cathode-side reaction gas, a second condenser 35 can be provided upstream of the second water separator 32, which can have a cooling circuit with a coolant supply 351 and a coolant discharge 352. The coolant circuits of the condensers 34, 35 can be connected to the fluid cooling device 40 of the fuel cell system 12 or its coolant circuit (not shown).

The separated water from both the water separators 31, 32 and the condensers 34, 35 can be collected in a water reservoir 33 of the recovery device 30.

From there, the water can be fed to the ram air flow 22 by the supply device 50. For this purpose, the supply device 50 has a pump 52 to pump the water. By a pulse valve 53 downstream of the pump 52, a water flow rate at the nozzle device 51 can be regulated or controlled.

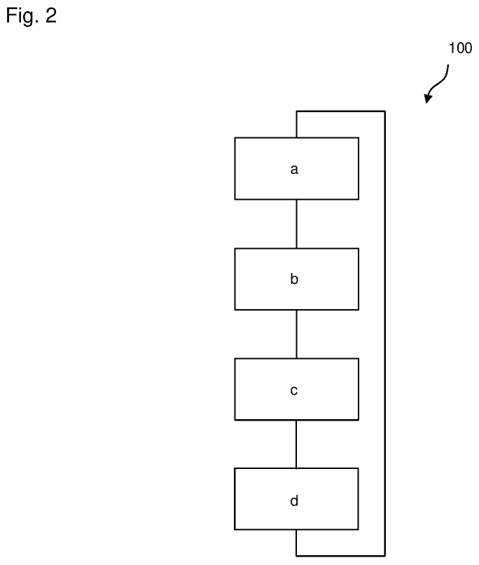

FIG. 2 shows a schematic representation of a flow chart of an exemplary method 100 for operating an aircraft fuel cell propulsion unit 10 described herein with a fuel cell system 12.

The steps of the method 100 can in particular be carried out simultaneously or in a modified order and thus deviate from the sequence shown.

In a step a, the ram air duct 21 is flowed through with ram pressure air 22.

In a step b, the fuel cell system 12 is operated to provide energy for an aircraft engine, and in a step c, water can be recovered from a reaction gas of the fuel cell system 12, in particular by the recovery device 30.

In a step d, water is supplied to the ram air flow 22 by the supply device 50 before it enters the heat exchanger 20. In this case, a volume flow and/or a degree of atomization of the water to be introduced can be controlled and/or regulated depending on parameters of the aircraft fuel cell propulsion unit 10 in order to increase the heat exchange performance of the heat exchanger to be able to adapt to operating conditions, for example of aircraft fuel cell propulsion unit.

1. An aircraft fuel cell propulsion unit with a fuel cell system which has at least one anode and at least one cathode and a process gas device for supplying the anode and the cathode with fuel and ambient air and for discharging used process gases, a ram air duct through which ram pressure air flows, and a heat exchanger arranged in the ram air duct which is designed to dissipate heat generated by the fuel cell system to the environment, wherein a supply device is arranged upstream of the heat exchanger which is designed to introduce water into the ram air flow,
wherein the water is at least partially provided by a recovery device from the process gas of the fuel cell system.

2. The aircraft fuel cell propulsion unit according to claim 1, wherein the recovery device comprises at least one water separator.

3. The aircraft fuel cell propulsion unit according to claim 1, wherein the process gas is an anode-side reaction gas and/or a cathode-side reaction gas.

4. The aircraft fuel cell propulsion unit according to claim 1, wherein the supply device is arranged to introduce the water in atomized form into the ram air flow.

5. The aircraft fuel cell propulsion unit according to claim 1, wherein the supply device comprises a pulse valve.

6. A method for operating an aircraft fuel cell propulsion unit with a fuel cell system according to claim 1, wherein
a) the ram air channel is flowed through with ram pressure air;
b) the fuel cell system is operated;
c) water is obtained at least partially from a process gas of the fuel cell system; and
d) water is supplied to the ram air flow by means of the supply device.

7. The method according to claim 6, wherein the process gas is an anode-side reaction gas and/or a cathode-side reaction gas.

8. The method according to claim 6, wherein a volume flow of the water to be supplied is predetermined depending on parameters of the aircraft fuel cell propulsion unit by controlling the pulse valve.

9. The method according to claim 6, wherein a degree of atomization of the water to be introduced can be varied depending on parameters of the aircraft fuel cell propulsion unit.
